(19) United States
(12) Patent Application Publication
(10) Pub. No.: US 2026/0228946 A1
(43) Pub. Date: Aug. 6, 2026

(54) VIDEO PROCESSING METHOD AND APPARATUS, COMPUTER DEVICE, AND STORAGE MEDIUM

(71) Applicant: Douyin Vision Co., Ltd., Beijing (CN)

(72) Inventors: Yingjie ZHANG, Beijing (CN); Xiaopeng SUN, Beijing (CN); Hanbing ZHAN, Beijing (CN); Yifan ZHU, Beijing (CN); Shijie ZHAO, Beijing (CN); Wei FENG, Beijing (CN)

(21) Appl. No.: 19/152,924

(22) PCT Filed: Mar. 19, 2024
(86) PCT No.: PCT/CN2024/082452

§ 371 Date: Jul. 31, 2025

(30) Foreign Application Priority Data
Mar. 28, 2023 (CN) 202310318135.1

(51) Int. Cl. G06T 11/60; G06T 3/403; G06T 3/4038; G06T 5/70; G06T 7/13

(52) U.S. Cl. CPC G06T 11/60; G06T 3/403; G06T 3/4038; G06T 5/70; G06T 7/13; G06T 2207/10016; G06T 2207/20221

(57) ABSTRACT

The present disclosure provides a video processing method and apparatus, a computer device, and a storage medium. The video processing method includes: receiving a first target image from a central processing unit, where the first target image includes an image decoded by the central processing unit from a source video; performing first fusion processing on the first target image and a second target image, to obtain a third target image, wherein the second target image is obtained by performing denoising processing on the first target image; and performing second fusion processing on a fourth target image and an image obtained by performing scaling processing on the third target image, to obtain a fifth target image, wherein the fourth target image is an image obtained by performing super-resolution processing on the third target image.

### CROSS-REFERENCE TO RELATED APPLICATIONS

The present application is based on and claims priority to Chinese Application No. 202310318135.1,filed on Mar. 28, 2023, the disclosure of which is incorporated herein by reference in its entirety.

### TECHNICAL FIELD

The present disclosure relates to the field of video processing, and in particular, to a video processing method and apparatus, a computer device, and a non-transitory storage medium.

### BACKGROUND

With an increasing requirement of users for video resolution and image clarity, conventional video processing technologies cannot satisfy the actual requirement A conventional video processing solution generally uses a single device (for example, a central processing unit (CPU)) to process a video stream, but cannot satisfy the requirement of an actual application. Therefore, the related art further uses a device with a large-scale computing function (for example, a graphics processing unit (GPU)) to process the video stream, so as to improve the processing performance of the video stream.

### SUMMARY

The present disclosure can provide a video processing method and apparatus, a computer device, and a non-transitory storage medium.

The present disclosure can provide a video processing method, applied to a graphics processing unit, the method including: receiving a first target image from a central processing unit, where the first target image includes an image decoded by the central processing unit from a source video; performing first fusion processing on the first target image and a second target image, to obtain a third target image, where the second target image is obtained by performing denoising processing on the first target image, and the first fusion processing is configured to fuse the first target image and the second target image that both have a first size; and performing second fusion processing on a fourth target image and an image obtained by performing scaling processing on the third target image, to obtain a fifth target image, where the fourth target image is an image obtained by performing super-resolution processing on the third target image; and the second fusion processing is configured to fuse the fourth target image and the image obtained by performing scaling processing on the third target image that both have a second size.

The present disclosure can further provide a video processing apparatus, applied to a graphics processing unit, the apparatus including: an image receiving module, configured to receive a first target image from a central processing unit, where the first target image includes an image decoded by the central processing unit from a source video; a first fusion module, configured to perform first fusion processing on the first target image and a second target image, to obtain a third target image, where the second target image is obtained by performing denoising processing on the first target image, and the first fusion processing is configured to fuse the first target image and the second target image that both have a first size; and a second fusion module, configured to perform second fusion processing on a fourth target image and an image obtained by performing scaling processing on the third target image, to obtain a fifth target image, where the fourth target image is an image obtained by performing super-resolution processing on the third target image; and the second fusion processing is configured to fuse the fourth target image and the image obtained by performing scaling processing on the third target image that both have a second size.

The present disclosure can further provide a computer device, including a memory and a processor, where the memory stores computer-readable instructions, and the computer-readable instructions, when executed by the processor, cause the processor to execute the video processing method according to any one of the embodiments of the present disclosure.

The present disclosure can further provide a non-transitory storage medium storing computer-readable instructions, where the computer-readable instructions, when executed by one or more processors, cause the one or more processors to execute the video processing method according to any one of the embodiments of the present disclosure.

The present disclosure can further provide a computer program, where the computer program, when executed by a processor, implements the video processing method according to any one of the embodiments of the present disclosure.

The present disclosure can further provide a computer program product, including a computer program, where the computer program, when executed by a processor, implements the video processing method according to any one of the embodiments of the present disclosure.

### BRIEF DESCRIPTION OF THE DRAWINGS

FIG. 1 shows a flowchart of a video processing method according to one or more embodiments of the present disclosure.

FIG. 2 shows a flowchart of performing first fusion processing on a first target image and a second target image according to one or more embodiments of the present disclosure.

FIG. 3 shows a flowchart of performing parallel processing on the first target image and the second target image according to one or more embodiments of the present disclosure.

FIG. 4 shows a flowchart of performing edge extraction processing on the first target image that has been subjected to Gaussian blur processing according to one or more embodiments of the present disclosure.

FIG. 5 shows a flowchart of performing second fusion processing on a fourth target image and a third target image that has been subjected to scaling processing according to one or more embodiments of the present disclosure.

FIG. 6 shows a flowchart of performing an edge point conversion process for a preset number of times according to one or more embodiments of the present disclosure.

FIG. 7 shows a flowchart of an implementation of the video processing method according to one or more embodiments of the present disclosure.

FIG. 8 shows a structural diagram of a video processing apparatus according to one or more embodiments of the present disclosure.

FIG. 9 shows a schematic diagram of an internal structure of a computer device according to one or more embodiments of the present disclosure.

### DETAILED DESCRIPTION OF EMBODIMENTS

With continuous development of computer technologies, deep neural networks have become increasingly popular in fields such as natural language processing and video processing. In a process of implementing a video processing function based on a neural network model, a large number of matrix or convolution operation operators need to be used. If only a CPU is used for processing, a requirement of an actual application cannot usually be satisfied. Therefore, the related art further needs to perform heterogeneous computing in combination with a GPU, so as to better implement the video processing function.

In the related art, a neural network model is generally deployed in a GPU, and first intermediate processing result data generated by the GPU is sent to a CPU. Second intermediate processing result data generated by the CPU is sent to the GPU. In a video processing process, interaction processes of the intermediate processing result data are often performed for many times. This case causes additional data transmission, and the additional data transmission results in a decrease in processing performance of a video stream and additional storage overheads.

In view of this, the present disclosure provides a video processing method and apparatus, a computer device, and a non-transitory storage medium, to solve at least one problem in the related art.

As shown in FIG. 1, at least one embodiment of the present disclosure can provide a video processing method. The processing method is applied to a graphics processing unit. The processing method may include but is not limited to step S101 to step S103, which are specifically described below.

Step S101: Receive a first target image from a central processing unit, where the first target image includes an image decoded by the central processing unit from a source video.

In this embodiment of the present disclosure, the source video is one or more videos in a to-be-processed video stream.

In this embodiment of the present disclosure, the video stream includes a plurality of source videos. The central processing unit is configured to: obtain a source video from the video stream, decode the first target image from the source video, and send the first target image to the graphics processing unit.

Optionally, decoding the first target image from the source video includes: extracting the first target image from the source video at a predetermined frequency, or extracting each frame of image from the source video as the first target image, where a plurality of first target images are obtained.

As an example, in this embodiment, the first target image is parsed from the source video through a pre-written program (for example, a C/C++, Python, or Golang program).
Step S102: Perform first fusion processing on the first target image and a second target image, to obtain a third target image, where the second target image is obtained by performing denoising processing on the first target image, and the first fusion processing is configured to fuse the first target image and the second target image that both have a first size.

The first target image and the second target image have the same image size, and both have the first size.

In this embodiment, the graphics processing unit is configured to perform denoising processing on the first target image, and specifically, perform denoising processing on an input image by using a denoising neural network model that is disposed in the graphics processing unit, where the denoising neural network model is a trained denoising neural network model.

The denoising neural network model may specifically be a deblocking model based on a residual network. The denoising neural network model includes but is not limited to a convolutional layer, an activation layer, a residual block, a maximum pooling layer, and an average pooling layer. Based on the convolutional layer, the activation layer, the residual block, and the like, the denoising neural network model is configured to perform feature extraction processing on the first target image, and perform denoising processing on the first target image based on a result of the feature extraction, to obtain the second target image.

The size of the first target image is H×W×C, and the size of the second target image is H×W×C, where H represents the image height, W represents the image width, and C represents the number of image channels, that is, the first target image and the second target image have the same dimension.

Denoising the input image is an important application in the field of video processing based on a deep neural network. The input image is denoised by using the neural network, to generate an image with clearer image quality.

In this embodiment, the first target image and the second target image are specifically fused into the third target image. Compared with the first target image and the second target image, the third target image is an image with enhanced image quality.
Step S103: Perform second fusion processing on a fourth target image and an image obtained by performing scaling processing on the third target image, to obtain a fifth target image, where the fourth target image is an image obtained by performing super-resolution processing on the third target image; and the second fusion processing is configured to fuse the fourth target image and the image obtained by performing scaling processing on the third target image that both have a second size.

The fourth target image and the image obtained by performing scaling processing on the third target image have the same image size, and both have the second size. For example, the second size is 2000×2000 pixels, and the first size is 1000×1000 pixels.

In this embodiment, the graphics processing unit is configured to perform super-resolution processing on the third target image, and specifically, perform super-resolution processing on an input image by using a super-resolution neural network model that is disposed in the graphics processing unit, where the super-resolution neural network model is a trained super-resolution neural network model.

Specifically, the super-resolution neural network model may specifically be a super-resolution model based on a residual network. The super-resolution model may include but is not limited to a convolutional layer, an activation layer, and a residual block. Based on the convolutional layer, the activation layer, the residual block, and the like, the super-resolution model is configured to perform feature extraction processing on the third target image, and perform super-resolution processing on the third target image based on a result of the feature extraction, to obtain the fourth target image with higher resolution.

In one or more embodiments of the present disclosure, the size of the third target image may be, for example, H×W×C, and the size of the fourth target image may be, for example, 2H×2W×C. It may be learned that in this embodiment, the fourth target image with a resolution twice the resolution of the third target image is obtained. Certainly, the present disclosure is not limited thereto.

Performing super-resolution on the input image is an important application in the field of video processing based on a deep neural network. The input image is subjected to super-resolution processing by using the neural network, to generate an image with higher resolution.

In one or more embodiments of the present disclosure, a process of performing the second fusion processing on the third target image and the fourth target image may be the same as a working process of performing the first fusion processing on the first target image and the second target image.

After the fifth target image is generated, the fifth target image is sent to the central processing unit in this embodiment. The central processing unit is further configured to encode the fifth target image into a target video.

The central processing unit in this embodiment is configured to receive the fifth target image and encode the fifth target image into a target video with better image quality and higher resolution.

Compared with an existing heterogeneous processing solution for a video stream, the present disclosure avoids a process of additional data transmission, and reduces data transmission time, thereby greatly improving real-time processing performance of the video stream. Moreover, compared with a problem of additional data storage caused by transmission of intermediate processing result data in the related art, for example, a problem of insufficient storage space that is often faced when one GPU card is used in the related art, the present disclosure can further significantly improve utilization of the storage space of the device, thereby improving utilization of the device and allowing one GPU card to process more video streams at the same time.

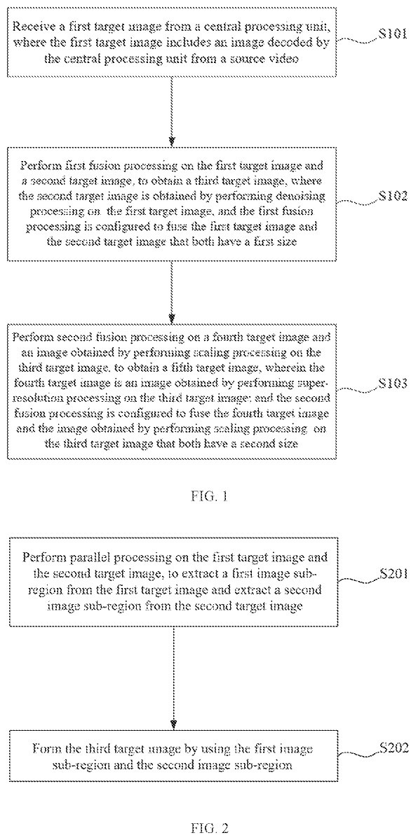

As shown in FIG. 2, in at least one embodiment of the present disclosure, performing the first fusion processing on the first target image and the second target image includes but is not limited to step S201 and step S202.
Step S201: Perform parallel processing on the first target image and the second target image, to extract a first image sub-region from the first target image and extract a second image sub-region from the second target image.

In this embodiment, performing parallel processing on the first target image and the second target image includes: processing the first target image and the second target image at the same time. A first relative position of the first image sub-region in the first target image is different from a second relative position of the second image sub-region in the second target image.
Step S202: Form the third target image by using the first image sub-region and the second image sub-region. For example, the third target image is formed by combining the first image sub-region and the second image sub-region.

By means of performing parallel processing on the first target image and the second target image by using the GPU, the efficiency of image fusion processing can be improved in this embodiment. Forming the third target image based on the first image sub-region and the second image sub-region is helpful to significantly improve the image quality of the third target image.

The first image sub-region in one or more embodiments of the present disclosure is an edge region image in the first target image, and the second image sub-region is a non-edge region image in the second target image. The “edge region” involved in the present disclosure represents an area where a set of pixels with stepwise or ridge-like variations in image characteristics (such as pixel grayscale or texture) is located. The edge region image involved in the present disclosure is an image including an edge region in the first target image, and the non-edge region image is an image including a non-edge region in the second target image.

In this embodiment, forming the third target image by using the first image sub-region and the second image sub-region includes: stitching the edge region image and the non-edge region image into the third target image.

Based on the preceding improved solution, in this embodiment, the edge region in the first target image is retained on the basis of performing the denoising processing on the first target image. This can effectively mitigate the image over-smoothing phenomenon that may be caused by the denoising processing.

As shown in FIG. 3, in one or more embodiments of the present disclosure, performing parallel processing on the first target image and the second target image includes but is not limited to step S301 and step S302
Step S301: Process the first target image based on a first fusion operator, to obtain a first mask image; and process the second target image based on a second fusion operator, to obtain a second mask image.

The first mask image in this embodiment is used as a mask for subsequent cutout processing performed on the first target image, and the second mask image is used as a mask for subsequent cutout processing performed on the second target image.
Step S302: Cut out the first image sub-region from the first target image based on the first mask image, and cut out the second image sub-region from the second target image based on an inverse mask image corresponding to the second mask image.

In this embodiment, the first target image may be represented by using a first input vector, and the first mask image may be represented by using a first mask vector. Values in the first mask vector include 1 and 0, where I corresponds to an image region (for example, a pixel) to be retained, and 0 corresponds to an image region (for example, a pixel) not to be retained.

In this embodiment, a vector used to characterize the first image sub-region may be obtained by multiplying the first input vector by the first mask vector, and the first image sub-region is determined based on the vector used to characterize the first image sub-region, to implement cutting out the first image sub-region from the first target image.

In this embodiment, the second target image may be represented by using a second input vector, and the second mask image may be represented by using a second mask vector. Values in the second mask vector include 1 and 0, where 1 corresponds to an image region to be retained, and 0 corresponds to an image region not to be retained. The inverse mask image corresponding to the second mask image is represented by using a third mask vector. Values in the third mask vector include 0 and 1, where 0 in the third mask vector corresponds to 1 in the second mask vector, and 1 in the third mask vector corresponds to 0 in the second mask vector. In this embodiment, a vector used to characterize the second image sub-region may be obtained by multiplying the second input vector by the third mask vector, and then the second image sub-region is determined based on the vector used to characterize the second image sub-region, to implement cutting out the second image sub-region from the second target image.

The first fusion operator is configured to perform Gaussian blur processing, edge extraction processing, and dilation processing on the first target image in sequence, and the second fusion operator is configured to perform Gaussian blur processing, edge extraction processing, and dilation processing on the second target image in sequence.

The second fusion operator involved in the present disclosure has a same function and implementation logic as the first fusion operator, and both are implemented by using a parallel programming language based on a compute unified device architecture (CUDA) framework.

Based on the preceding improved technical solution, the present disclosure can further provide a video processing method based on a fusion operator. Based on the manner of cutting out the first image sub-region from the first target image and cutting out the second image sub-region from the second target image, in this embodiment, the respective advantages of the first image sub-region and the second image sub-region are utilized, to achieve the objective of constructing an image with enhanced image quality by using the first image sub-region and the second image sub-region.

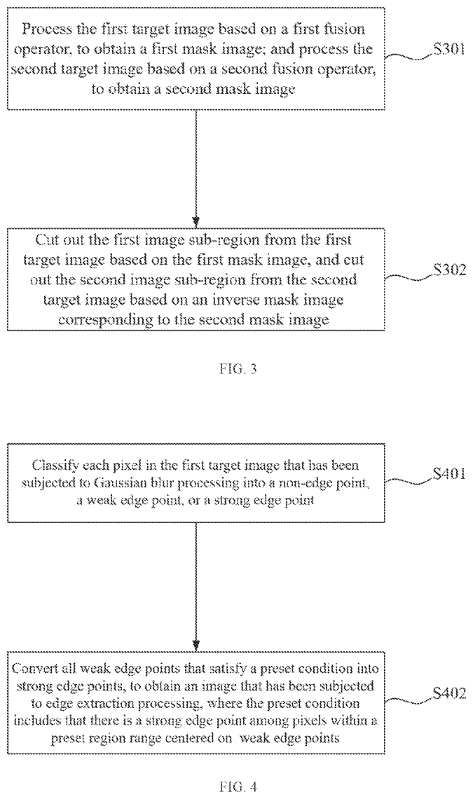

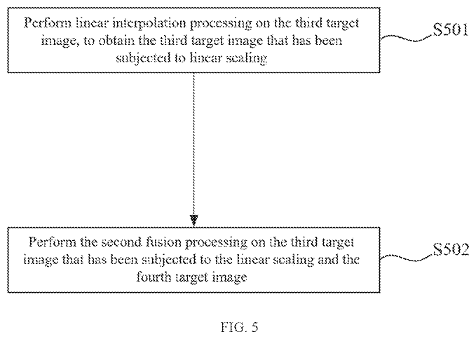

As shown in FIG. 4, in at least one embodiment of the present disclosure, processing the first target image based on the first fusion operator includes performing edge extraction processing on the first target image that has been subjected to Gaussian blur processing.

Specifically, in at least one embodiment of the present disclosure, performing the edge extraction processing on the first target image that has been subjected to Gaussian blur processing includes but is not limited to step S401 and step S402.
Step S401: Classify each pixel in the first target image that has been subjected to Gaussian blur processing into a non-edge point, a weak edge point, or a strong edge point.

After the classification, pixels in the first target image include three types: non-edge points, weak edge points, and strong edge points.

In this embodiment, feature identification is specifically performed on the first target image that has been subjected to the Gaussian blur processing, and pixels is determined as non-edge points, weak edge points, or strong edge points based on the result of the feature identification. The result of the feature identification may be a gray value. For example, a pixel whose gray value is within a first preset threshold range is determined as a strong edge point, a pixel whose gray value is within a second preset threshold range is determined as a weak edge point, and a pixel whose gray value is within a third preset threshold range is determined as a non-edge point.

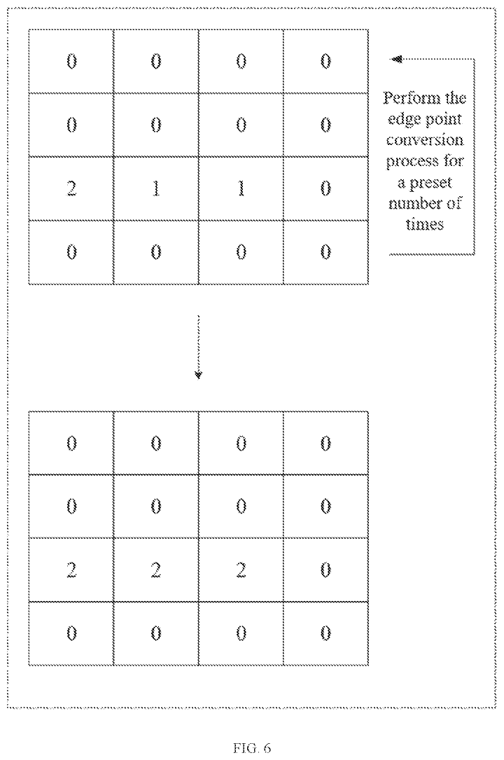

As shown in FIG. 6, in this embodiment, a pixel as a non-edge point is marked as “0”, a pixel as a weak edge point is marked as “1”, and a pixel as a strong edge point is marked as “2”. Certainly, the present disclosure is not limited thereto.
Step S402: Convert all weak edge points that satisfy a preset condition into strong edge points, to obtain an image that has been subjected to edge extraction processing, where the preset condition includes that there is a strong edge point among pixels within a preset region range centered on weak edge points.

Based on the preceding technical means for edge extraction, in the embodiments of the present disclosure, a pixel belonging to the edge region can also be accurately determined by using a pixel as a minimum unit, so that the edge region is accurately divided from the image.

In one or more embodiments of the present disclosure, converting all weak edge points that satisfy the preset condition into strong edge points includes: performing an edge point conversion process for a preset number of times, where the edge point conversion process includes: determining a weak edge point by performing parallel identification on a plurality of pixels and converting the weak edge point that satisfies the preset condition into a strong edge point, until identification is performed on each pixel.

The preset number of times is at least two times. A specific value of the preset number of times may be set based on an actual situation. In a preferred embodiment of the present disclosure, the preset number of times is 16 times. Certainly, the present disclosure is not limited thereto.

In each edge point conversion process, a plurality of pixels are processed in parallel in this embodiment, including identifying the plurality of pixels and converting an identified weak edge point into a strong edge point.

For any weak edge point, if the edge point conversion process is performed only once, a problem of missing weak edge point conversion (that is, missing detection) may occur. As shown in FIG. 6, two weak edge points “1” are included. If the edge point conversion process is performed only once, the preset condition is, for example, that there is a strong edge point among the pixels adjacent to the weak edge point, and only one weak edge point adjacent to the strong edge point “2” is then converted into a strong edge point, and the other weak edge point is not converted into a strong edge point. In practice, after one weak edge point is converted into a new strong edge point, a weak edge point around the new strong edge point also needs to be converted into a strong edge point. To solve this problem, the edge point conversion processes are performed for a plurality of times in this embodiment.

In this way, in the embodiments of the present disclosure, the problem of missing detection that may occur in the edge point conversion process can be effectively reduced or even avoided by means of performing the edge point conversion processes for the preset number of times, and the reliability of the edge point conversion process in the present disclosure is improved, so that the image quality of the processed image is improved.

In one or more embodiments of the present disclosure, determining the weak edge point by performing parallel identification on the plurality of pixels and converting the weak edge point that satisfies the preset condition into the strong edge point includes: allocating a preset number of threads, and identifying the weak edge point from the plurality of pixels and converting the weak edge point that satisfies the preset condition into the strong edge point through the preset number of threads.

The preset number of threads is provided by the GPU. For example, the preset number of threads in one or more embodiments of the present disclosure is 8192 threads. Taking 8192 threads as an example, 8192 pixels can be identified at the same time, and the weak edge point that satisfies the preset condition can be converted into the strong edge point.

Based on the preceding improved technical solution, in the embodiments of the present disclosure, the advantage of the GPU in simultaneous execution of a plurality of threads can be fully exerted, and the efficiency of processing the pixel is improved, thereby significantly improving utilization of the device and further improving the video processing performance of the present disclosure.

In one or more embodiments of the present disclosure, the preset condition is that there is a strong edge point among the pixels adjacent to the weak edge point.

The pixel adjacent to the weak edge point in this embodiment includes eight pixels distributed around the weak edge point.

As shown in FIG. 6, two weak edge points “1” are shown in the figure. In one edge point conversion process, one weak edge point “1” adjacent to the strong edge point “2” is converted into a new strong edge point “2”. In another edge point conversion process, the weak edge point “1” adjacent to the new strong edge point “2” is also converted into the strong edge point “2”.

Based on the determination of the strong edge point adjacent to the weak edge point, in the embodiments of the present disclosure, the precision of the edge point conversion process can be further improved, so that the edge region in the image is determined more accurately, and a more accurate mask image is obtained, thereby achieving the objective of significantly enhancing the image quality.

In one or more embodiments of the present disclosure, processing the first target image based on the first fusion operator further includes performing dilation processing on the image that has been subjected to the edge extraction processing.

In this embodiment, performing the dilation processing on the image that has been subjected to the edge extraction processing includes performing maximum pooling processing on the image that has been subjected to the edge extraction processing, to obtain the first mask image, where the first mask image is a binary image.

For example, in this embodiment, the first mask image whose gray values include 0 and 255 may be obtained by the maximum pooling processing, so as to achieve the objectives of enhancing an image edge and an image background.

In this embodiment, a maximum pooling layer in the denoising neural network model may be reused, and the maximum pooling processing is performed on the image that has been subjected to the edge extraction processing by using the maximum pooling layer, so that the utilization rate of the model is further improved.

In the present disclosure, the objective of effectively enhancing the image edge and the background can be achieved by means of performing the maximum pooling processing on the image, to obtain the first mask image in the form of a binary image, so as to achieve the objective of selecting the first image sub-region from the first target image more accurately.

In one or more embodiments of the present disclosure, processing the first target image based on the first fusion operator further includes: performing Gaussian blur processing on the first target image, to obtain the first target image that has been subjected to the Gaussian blur processing.

In this embodiment, performing the Gaussian blur processing on the first target image includes: performing convolution operation processing and pooling operation processing on the first target image. The convolution operation processing is, for example, processing the first target image by using Gaussian blur convolution, and the pooling operation processing is, for example, average pooling processing.

The Gaussian blur convolution processing in one or more embodiments of the present disclosure can reuse the convolutional layer and the average pooling layer in the denoising neural network model, thereby significantly improving the utilization rate of the denoising neural network model.

In the present disclosure, based on the preceding solution, the first target image may be preprocessed by means of the Gaussian blur processing. The image obtained after the preprocessing can effectively reduce a case of misjudgment in the edge extraction process, so that a pixel is more accurately identified as a non-edge point, a weak edge point, or a strong edge point.

As shown in FIG. 5, in at least one embodiment of the present disclosure, performing the second fusion processing on the fourth target image and the third target image that has been subjected to the scaling processing includes but is not limited to step S501 and step S502.
Step S501: Perform linear interpolation processing on the third target image, to obtain the third target image that has been subjected to linear scaling.

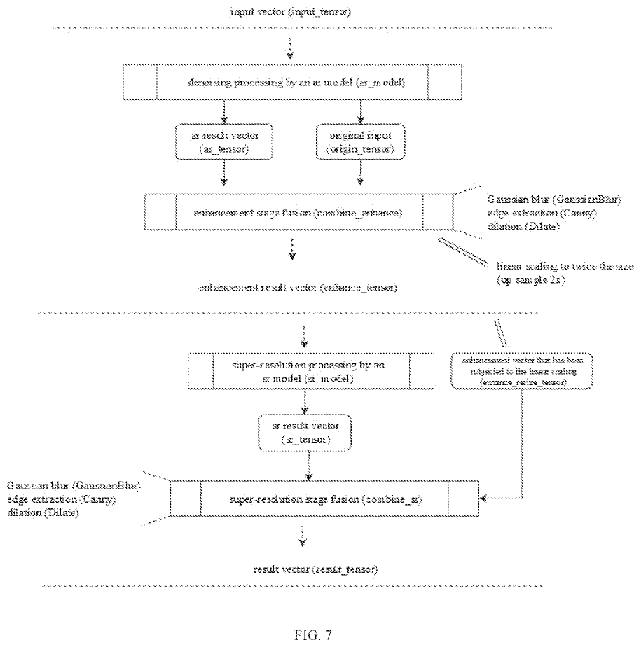

As shown in FIG. 7, in this embodiment, the third target image may be linearly scaled to twice the size by means of the linear interpolation processing. For example, in this embodiment, an image of 1000×1000 pixels is scaled to an image of 2000×2000 pixels by means of interpolation. Certainly, the present disclosure is not limited thereto.
Step S502: Perform the second fusion processing on the third target image that has been subjected to the linear scaling and the fourth target image.

In this embodiment, the third target image that has been subjected to the linear scaling and the fourth target image are fused, which is helpful to further improve the fusion effect of the third target image and the fourth target image, that is, to achieve the objective of further improving the resolution of the input image.

In at least one embodiment of the present disclosure, performing the second fusion processing on the fourth target image and the third target image that has been subjected to the scaling processing includes: performing parallel processing on the third target image that has been subjected to the scaling processing and the fourth target image, to extract a third image sub-region from the third target image and extract a fourth image sub-region from the fourth target image; and forming the fifth target image by using the third image sub-region and the fourth image sub-region. In this embodiment, the efficiency of image fusion processing can be improved by means of performing parallel processing on the third target image and the fourth target image, so that the image quality of the fifth target image is significantly improved.

In at least one embodiment of the present disclosure, the third image sub-region is an edge region image in the third target image, and the fourth image sub-region is a non-edge region image in the fourth target image. Forming the fifth target image by using the third image sub-region and the fourth image sub-region includes: stitching the edge region image in the third target image and the non-edge region image in the fourth target image into the fifth target image. Based on the preceding improved solution, in this embodiment, the edge region in the third target image is retained on the basis of performing the super-resolution processing on the third target image. This can effectively mitigate the image over-sharpening phenomenon that may be caused by the super-resolution processing.

In one or more embodiments of the present disclosure, forming the fifth target image by using the third image sub-region and the fourth image sub-region includes: processing the third target image based on a third fusion operator, to obtain a third mask image, and processing the fourth target image based on a fourth fusion operator, to obtain a fourth mask image; and cutting out the third image sub-region from the third target image based on the third mask image, and cutting out the fourth image sub-region from the fourth target image based on the fourth mask image. The third fusion operator is configured to perform Gaussian blur processing, edge extraction processing, and dilation processing on the third target image in sequence, and the fourth fusion operator is configured to perform Gaussian blur processing, edge extraction processing, and dilation processing on the fourth target image in sequence.

In the embodiments of the present disclosure, the respective advantages of the third image sub-region and the fourth image sub-region can be utilized, to achieve the objective of constructing an image with higher resolution by using the third image sub-region and the fourth image sub-region.

Processing the third target image based on the third fusion operator includes performing edge extraction processing on the third target image that has been subjected to Gaussian blur processing. Performing the edge extraction processing on the third target image that has been subjected to Gaussian blur processing includes: classifying each pixel in the third target image that has been subjected to Gaussian blur processing into a non-edge point, a weak edge point, or a strong edge point; and converting all weak edge points that satisfy a preset condition into strong edge points, to obtain an image that has been subjected to edge extraction processing, where the preset condition includes that there is a strong edge point among pixels within a preset region range centered on weak edge points. In the embodiments of the present disclosure, a pixel belonging to the edge region can be accurately determined by using a pixel as a minimum unit, so that the edge region is accurately divided from the image.

In the embodiments of the present disclosure, converting all weak edge points that satisfy the preset condition into strong edge points includes: performing an edge point conversion process for the preset number of times; and the edge point conversion process includes: determining a weak edge point by performing parallel identification on a plurality of pixels and converting the weak edge point that satisfies the preset condition into a strong edge point, until identification is performed on each pixel. Based on the preceding manner of performing the edge point conversion process for the preset number of times, the present disclosure can further effectively reduce or even avoid the problem of missing detection that may occur in the edge point conversion process.

In one or more embodiments of the present disclosure, determining the weak edge point by performing parallel identification on the plurality of pixels and converting the weak edge point that satisfies the preset condition into the strong edge point includes: allocating the preset number of threads, and identifying the weak edge point from the plurality of pixels and converting the weak edge point that satisfies the preset condition into the strong edge point through the preset number of threads. The preset condition is that there is a strong edge point among the pixels adjacent to the weak edge point. Based on the preceding solution, the present disclosure can fully exert the advantage of the GPU in simultaneous execution of a plurality of threads, and improve the efficiency of processing the pixel, so as to significantly improve the utilization of the device, thereby further improving the video processing performance of the present disclosure.

In one or more embodiments of the present disclosure, processing the third target image based on the third fusion operator further includes performing dilation processing on the image that has been subjected to the edge extraction processing. Performing the dilation processing on the image that has been subjected to the edge extraction processing includes: performing maximum pooling processing on the image that has been subjected to the edge extraction processing, to obtain the third mask image, where the third mask image is a binary image. In the present disclosure, the objective of effectively enhancing the image edge and the background can be achieved by means of performing the maximum pooling processing on the image, to obtain the third mask image in the form of a binary image, so as to achieve the objective of selecting the third image sub-region from the third target image more accurately.

As shown in FIG. 7, in a specific implementation of the present disclosure, the first target image is input into the GPU in the form of a first input vector (input_tensor), and then the first input vector may be processed by using a denoising neural network model (for example, ar_model, autoregressive model), to obtain an ar result vector (ar_tensor) and an original input vector (origin_tensor). The ar result vector (which may alternatively be described as a second input vector) represents the second target image, and the original input vector is the same as the first input vector.

Fusing the ar result vector with the original input vector includes: performing Gaussian blur (GaussianBlur), edge extraction (Canny), and dilation (Dilate) processing on the ar result vector and the original input vector respectively, to obtain a first mask vector and a second mask vector; calculating a first vector product of the first mask vector and the original input vector, and calculating a second vector product of a third mask vector and the ar result vector, where the third mask vector represents an inverse mask image corresponding to the second mask image; and using a sum of the first vector product and the second vector product as an enhancement result vector (enhance_tensor), so that a function of image enhancement stage fusion (combine_enhance) is implemented.

Then, super-resolution processing is performed on the enhancement result vector by using a super-resolution model (sr_model, super-resolution_model), to obtain an sr result vector. In this embodiment of the present disclosure, linear scaling can be performed on the enhancement result vector, specifically, the linear scaling is performed by means of linear interpolation, to obtain an enhancement vector (enhance_resize_tensor) that has been subjected to the linear scaling. The sr result vector is fused with the enhancement vector that has been subjected to the linear scaling, including: performing Gaussian blur, edge extraction, and dilation processing on the sr result vector and the enhancement vector that has been subjected to the linear scaling respectively, to obtain a fourth mask vector and a fifth mask vector; and calculating a final result vector (result_tensor) based on the fourth mask vector and the fifth mask vector. A logical process of calculating the final result vector is the same as a logical process of calculating the enhancement result vector, so that a function of super-resolution stage (combine_sr) fusion is implemented.

According to the video processing method provided in this embodiment of the present disclosure, a data transmission process between the GPU and the CPU can be greatly reduced, and memory consumption and read and write operations of intermediate result data such as an operation intermediate in a storage space are significantly reduced. In some embodiments of the present disclosure, real-time high-quality super-resolution processing can be performed on three video streams at the same time on a single GPU card (for example, a single T4 card). Actual measurement shows that in the embodiments of the present disclosure, the processing speed of the video stream can be increased from 17 frames/second in the conventional technology to 39 frames/second.

As shown in FIG. 8, the video processing apparatus provided in one or more embodiments of the present disclosure is based on the same inventive concept as the video processing method provided in one or more embodiments of the present disclosure. One or more embodiments of the present disclosure can further provide a video processing apparatus, and the video processing apparatus is applied to a graphics processing unit, that is, the video processing apparatus can be integrated into the graphics processing unit.

The video processing apparatus includes but is not limited to an image receiving module 801, a first fusion module 802, and a second fusion module 803.

The image receiving module 801 is configured to receive a first target image from a central processing unit, where the first target image includes an image decoded by the central processing unit from a source video.

The first fusion module 802 is configured to perform first fusion processing on the first target image and a second target image, to obtain a third target image, where the second target image is obtained by performing denoising processing on the first target image, and the first fusion processing is configured to fuse the first target image and the second target image that both have a first size.

Optionally, the first fusion module includes a parallel processing module and an image forming module.

The parallel processing module is configured to perform parallel processing on the first target image and the second target image, to extract the first image sub-region from the first target image and extract the second image sub-region from the second target image.

The image forming module is configured to form the third target image by using the first image sub-region and the second image sub-region.

Optionally, the first image sub-region is an edge region image in the first target image, and the second image sub-region is a non-edge region image in the second target image. The image forming module is configured to stitch the edge region image and the non-edge region image into the third target image.

Optionally, the parallel processing module includes an image processing module and an image cutout module.

The image processing module is configured to process the first target image based on a first fusion operator, to obtain a first mask image, and process the second target image based on a second fusion operator, to obtain a second mask image.

The image cutout module is configured to cut out the first image sub-region from the first target image based on the first mask image, and cut out the second image sub-region from the second target image based on an inverse mask image corresponding to the second mask image.

The first fusion operator is configured to perform Gaussian blur processing, edge extraction processing, and dilation processing on the first target image in sequence, and the second fusion operator is configured to perform Gaussian blur processing, edge extraction processing, and dilation processing on the second target image in sequence.

Optionally, the image processing module is configured to perform edge extraction processing on the first target image that has been subjected to Gaussian blur processing. The image processing module includes a pixel classification module and a pixel conversion module.

The pixel classification module is configured to classify each pixel in the first target image that has been subjected to the Gaussian blur processing into a non-edge point, a weak edge point, or a strong edge point.

The pixel conversion module is configured to convert all weak edge points that satisfy the preset condition into strong edge points, to obtain the image that has been subjected to the edge extraction processing, where the preset condition includes that there is a strong edge point among the pixels within the preset region range centered on the weak edge points.

Optionally, the pixel conversion module is configured to perform the edge point conversion process for the preset number of times.

The edge point conversion process includes: determining the weak edge point by performing parallel identification on the plurality of pixels and converting the weak edge point that satisfies the preset condition into the strong edge point, until the identification is performed on each pixel.

Optionally, the pixel conversion module is configured to allocate the preset number of threads, and identify the weak edge point from the plurality of pixels and convert the weak edge point that satisfies the preset condition into the strong edge point through the preset number of threads.

Optionally, the preset condition is that there is the strong edge point in the pixel adjacent to the weak edge point.

Optionally, the image processing module is further configured to perform the dilation processing on the image that has been subjected to the edge extraction processing. The image processing module further includes a maximum pooling module.

The maximum pooling module is configured to perform the maximum pooling processing on the image that has been subjected to the edge extraction processing, to obtain the first mask image, where the first mask image is the binary image.

Optionally, the image processing module is further configured to perform Gaussian blur processing on the first target image, to obtain the first target image that has been subjected to the Gaussian blur processing.

The second fusion module 803 is configured to perform second fusion processing on the fourth target image and the third target image that has been subjected to the scaling processing, to obtain the fifth target image, where the fourth target image is the third target image that has been subjected to the super-resolution processing; and the second fusion processing is configured to fuse the fourth target image and the third target image that has been subjected to the scaling processing that both have the second size.

Optionally, the second fusion module 803 includes a linear interpolation module and a third fusion module.

The linear interpolation module is configured to perform linear interpolation processing on the third target image, to obtain the third target image that has been subjected to the linear scaling.

The third fusion module is configured to perform fusion processing on the third target image that has been subjected to the linear scaling and the fourth target image.

The video processing apparatus in this embodiment of the present disclosure may further include an image sending module. The image sending module is configured to send the fifth target image to the central processing unit. The central processing unit is further configured to encode the fifth target image into a target video.

In conclusion, the beneficial effects of the present disclosure at least include: In the present disclosure, compared with the related art, the data processing process of image reception, image denoising, first image fusion, image super-resolution, and second image fusion is performed by the graphics processing unit, so that the process of additional transmission of the intermediate processing result data is avoided. It may be learned that in the present disclosure, only the to-be-processed image and the processed image are transmitted between the central processing unit and the graphics processing unit. This significantly reduces the data transmission process between the central processing unit and the graphics processing unit, and improves the video processing efficiency and the utilization of the device, thereby greatly improving the real-time processing performance of the video stream. More video streams can be processed under a same hardware condition.

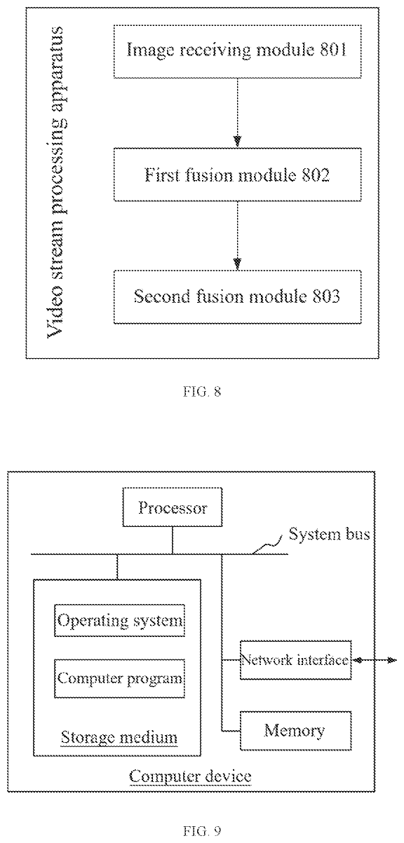

As shown in FIG. 9, the video processing method provided in one or more embodiments of the present disclosure is based on the same inventive concept as the video processing apparatus provided in one or more embodiments of the present disclosure. One or more embodiments of the present disclosure can further provide a computer device. The computer device includes a memory and a processor. The memory stores computer-readable instructions, and the computer-readable instructions, when executed by the processor, cause the processor to execute the video processing method according to any one of the embodiments of the present disclosure. The detailed process of the video processing method has been described in detail in this specification, and details are not described herein again.

As shown in FIG. 9, the video processing method provided in one or more embodiments of the present disclosure is based on the same inventive concept as the video processing apparatus provided in one or more embodiments of the present disclosure. One or more embodiments of the present disclosure can further provide a non-transitory storage medium storing computer-readable instructions. The computer-readable instructions, when executed by one or more processors, cause the one or more processors to execute the video processing method according to any one of the embodiments of the present disclosure. The detailed process of the video processing method has been described in detail in this specification, and details are not described herein again.

As shown in FIG. 9, the video processing method provided in one or more embodiments of the present disclosure is based on the same inventive concept as the video processing apparatus provided in one or more embodiments of the present disclosure. One or more embodiments of the present disclosure can further provide a computer program. The computer program, when executed by a processor, implements the video processing method according to any one of the embodiments of the present disclosure. The detailed process of the video processing method has been described in detail in this specification, and details are not described herein again.

As shown in FIG. 9, the video processing method provided in one or more embodiments of the present disclosure is based on the same inventive concept as the video processing apparatus provided in one or more embodiments of the present disclosure. One or more embodiments of the present disclosure can further provide a computer program product. The computer program product includes a computer program, and the computer program, when executed by a processor, implements the video processing method according to any one of the embodiments of the present disclosure.

The logic and/or steps represented in the flowcharts or described herein in other manners may be considered as a program list of executable instructions for implementing a logic function, and may be implemented in any computer-readable storage medium, for use by an instruction execution system, apparatus or device (such as a computer-based system, a system including a processor, or another system that can obtain instructions from the instruction execution system, apparatus or device and execute the instructions), or in combination with the instruction execution system, apparatus or device. For this specification, the “computer-readable storage medium” may be any apparatus that can include, store, communicate, propagate, or transmit a computer program for use by the instruction execution system, apparatus or device or in combination with the instruction execution system, apparatus or device. More specific examples (a non-exhaustive list) of the computer-readable storage medium include: an electrical connection portion (electronic apparatus) with one or more wires, a portable computer disk box (magnetic apparatus), a random-access memory (RAM, Random Access Memory), a read-only memory (ROM, Read-Only Memory), an erasable programmable read-only memory (EPROM, Erasable Programmable Read-Only Memory, or flash memory), an optical fiber apparatus, and a portable compact disc read-only memory (CDROM, Compact Disc Read-Only Memory). In addition, the computer-readable storage medium may even be paper or another suitable medium on which the program can be printed, because the program may be obtained electronically, for example, by optically scanning the paper or another medium, and then editing, interpreting, or processing the paper or another medium in another suitable manner if necessary, and then storing the program in a computer memory.

It should be understood that parts of the present disclosure may be implemented in hardware, software, firmware, or a combination thereof. In the preceding implementations, multiple steps or methods may be implemented by software or firmware stored in a memory and executed by a suitable instruction execution system. For example, if hardware is used for the implementation, as in another implementation, any one of the following technologies well-known in the art or a combination thereof may be used for the implementation: a discrete logic circuit having a logic gate circuit for implementing a logic function on a data signal, an application-specific integrated circuit (ASIC) having a suitable combination of logic gate circuits, a programmable gate array (PGA), a field programmable gate array (FPGA), or the like.

In the description of this specification, descriptions with reference to the terms “this embodiment”, “one embodiment”, “some embodiments”, “example”, “specific example”, or “some examples” and the like mean that the specific feature, structure, material, or characteristic described in combination with the embodiment or example is included in at least one embodiment or example of the present disclosure. In this specification, the schematic representations of the above terms are not necessarily directed to the same embodiment or example. Moreover, the specific feature, structure, material, or characteristic described may be combined in any one or more embodiments or examples in a suitable manner. In addition, without contradiction, a person skilled in the art may combine and integrate the different embodiments or examples described in this specification and the features of the different embodiments or examples.

In addition, the terms “first” and “second” are merely intended for description purposes, and cannot be understood as indicating or implying relative importance or implicitly indicating the number of indicated technical features. Therefore, the features defined as “first” and “second” may explicitly or implicitly include at least one such feature. In the description of the present disclosure, “a plurality of” means at least two, for example, two or three, unless otherwise specifically defined.

The above are merely preferred embodiments of the present disclosure, and are not intended to limit the present disclosure. Any modification, equivalent replacement, or simple improvement made on the substantial content of the present disclosure shall be included in the protection scope of the present disclosure.

1. A video processing method, applied to a graphics processing unit, the method comprising:
receiving a first target image from a central processing unit, wherein the first target image comprises an image decoded by the central processing unit from a source video;
performing first fusion processing on the first target image and a second target image, to obtain a third target image, wherein the second target image is obtained by performing denoising processing on the first target image, and the first fusion processing is configured to fuse the first target image and the second target image that both have a first size; and
performing second fusion processing on a fourth target image and an image obtained by performing scaling processing on the third target image, to obtain a fifth target image, wherein the fourth target image is an image obtained by performing super-resolution processing on the third target image; and the second fusion processing is configured to fuse the fourth target image and the image obtained by performing scaling processing on the third target image that both have a second size.

2. The video processing method according to claim 1, wherein performing the first fusion processing on the first target image and the second target image comprises:
performing parallel processing on the first target image and the second target image, to extract a first image sub-region from the first target image and extract a second image sub-region from the second target image; and
forming the third target image by using the first image sub-region and the second image sub-region.

3. The video processing method according to claim 2, wherein the first image sub-region is an edge region image in the first target image, and the second image sub-region is a non-edge region image in the second target image; and
forming the third target image by using the first image sub-region and the second image sub-region comprises:
stitching the edge region image and the non-edge region image into the third target image.

4. The video processing method according to claim 2, wherein performing parallel processing on the first target image and the second target image comprises:
processing the first target image based on a first fusion operator, to obtain a first mask image; and processing the second target image based on a second fusion operator, to obtain a second mask image; and
cutting out the first image sub-region from the first target image based on the first mask image, and cutting out the second image sub-region from the second target image based on an inverse mask image corresponding to the second mask image;
wherein the first fusion operator is configured to perform Gaussian blur processing, edge extraction processing, and dilation processing on the first target image in sequence, and the second fusion operator is configured to perform Gaussian blur processing, edge extraction processing, and dilation processing on the second target image in sequence.

5. The video processing method according to claim 4, wherein processing the first target image based on the first fusion operator comprises performing edge extraction processing on the first target image that has been subjected to Gaussian blur processing; and
performing the edge extraction processing on the first target image that has been subjected to Gaussian blur processing comprises:
classifying each pixel in the first target image that has been subjected to Gaussian blur processing into a non-edge point, a weak edge point, or a strong edge point; and
converting all weak edge points that satisfy a preset condition into strong edge points, to obtain an image that has been subjected to edge extraction processing, wherein the preset condition comprises that there is a strong edge point among pixels within a preset region range centered on weak edge points.

6. The video processing method according to claim 5, wherein converting all weak edge points that satisfy the preset condition into strong edge points comprises:
performing an edge point conversion process for a preset number of times, wherein the edge point conversion process comprises: determining a weak edge point by performing parallel identification on a plurality of pixels and converting the weak edge point that satisfies the preset condition into a strong edge point, until identification is performed on each pixel.

7. The video processing method according to claim 6, wherein determining the weak edge point by performing parallel identification on the plurality of pixels and converting the weak edge point that satisfies the preset condition into the strong edge point comprises:
allocating a preset number of threads, and identifying the weak edge point from the plurality of pixels and converting the weak edge point that satisfies the preset condition into the strong edge point through the preset number of threads.

8. The video processing method according to claim 5, wherein the preset condition is that there is a strong edge point among the pixels adjacent to the weak edge point.

9. The video processing method according to claim 4, wherein processing the first target image based on the first fusion operator further comprises performing dilation processing on the image that has been subjected to the edge extraction processing; and
performing the dilation processing on the image that has been subjected to the edge extraction processing comprises:
performing maximum pooling processing on the image that has been subjected to the edge extraction processing, to obtain the first mask image, wherein the first mask image is a binary image.

10. The video processing method according to claim 1, wherein performing the second fusion processing on the fourth target image and the third target image that has been subjected to the scaling processing comprises:
performing linear interpolation processing on the third target image, to obtain the third target image that has been subjected to linear scaling; and
performing the second fusion processing on the third target image that has been subjected to the linear scaling and the fourth target image.

11. (canceled)

12. A computer device, comprising a memory and a processor, wherein the memory stores computer-readable instructions, and the computer-readable instructions, when executed by the processor, cause the processor to execute the video processing method according to claim 1.

13. A non-transitory storage medium storing computer-readable instructions, wherein the computer-readable instructions, when executed by one or more processors, cause the one or more processors to execute the video processing method according to claim 1.

14. (canceled)

15. (canceled)

16. The video processing method according to claim 3, wherein performing parallel processing on the first target image and the second target image comprises:
processing the first target image based on a first fusion operator, to obtain a first mask image; and processing the second target image based on a second fusion operator, to obtain a second mask image; and
cutting out the first image sub-region from the first target image based on the first mask image, and cutting out the second image sub-region from the second target image based on an inverse mask image corresponding to the second mask image;
wherein the first fusion operator is used to perform Gaussian blur processing, edge extraction processing, and dilation processing on the first target image in sequence, and the second fusion operator is used to perform Gaussian blur processing, edge extraction processing, and dilation processing on the second target image in sequence.

17. The video processing method according to claim 6, wherein the preset condition is that there is a strong edge point among the pixels adjacent to the weak edge point.

18. The video processing method according to claim 7, wherein the preset condition is that there is a strong edge point among the pixels adjacent to the weak edge point.

19. The video processing method according to claim 5, wherein processing the first target image based on the first fusion operator further comprises performing dilation processing on the image that has been subjected to the edge extraction processing; and
performing the dilation processing on the image that has been subjected to the edge extraction processing comprises:
performing maximum pooling processing on the image that has been subjected to the edge extraction processing, to obtain the first mask image, wherein the first mask image is a binary image.

20. The video processing method according to claim 6, wherein processing the first target image based on the first fusion operator further comprises performing dilation processing on the image that has been subjected to the edge extraction processing; and
performing the dilation processing on the image that has been subjected to the edge extraction processing comprises:
performing maximum pooling processing on the image that has been subjected to the edge extraction processing, to obtain the first mask image, wherein the first mask image is a binary image.

21. The video processing method according to claim 7, wherein processing the first target image based on the first fusion operator further comprises performing dilation processing on the image that has been subjected to the edge extraction processing; and
performing the dilation processing on the image that has been subjected to the edge extraction processing comprises: performing maximum pooling processing on the image that has been subjected to the edge extraction processing, to obtain the first mask image, wherein the first mask image is a binary image.

22. The video processing method according to claim 8, wherein processing the first target image based on the first fusion operator further comprises performing dilation processing on the image that has been subjected to the edge extraction processing; and
performing the dilation processing on the image that has been subjected to the edge extraction processing comprises:
performing maximum pooling processing on the image that has been subjected to the edge extraction processing, to obtain the first mask image, wherein the first mask image is a binary image.

23. The video processing method according to claim 2, wherein performing the second fusion processing on the fourth target image and the third target image that has been subjected to the scaling processing comprises:
performing linear interpolation processing on the third target image, to obtain the third target image that has been subjected to linear scaling; and
performing the second fusion processing on the third target image that has been subjected to the linear scaling and the fourth target image.
